(19) United States
(12) Patent Application Publication
(10) Pub. No.: US 2021/0117687 A1
(43) Pub. Date: Apr. 22, 2021

(54) IMAGE PROCESSING METHOD, IMAGE PROCESSING DEVICE, AND STORAGE MEDIUM

(71) Applicant: SENSETIME INTERNATIONAL PTE. LTD., Singapore (SG)

(72) Inventors: Jiawei REN, Hong Kong (CN); Haining ZHAO, Hong Kong (CN); Shuai YI, Hong Kong (CN)

(21) Appl. No.: 17/080,221

(22) Filed: Oct. 26, 2020

Related U.S. Application Data
(63) Continuation of application No. PCT/CN2019/130420, filed on Dec. 31, 2019.

(30) Foreign Application Priority Data
Oct. 22, 2019 (CN) 201911007069.6

(51) Int. Cl. G06K 9/00; G06T 7/11

(52) U.S. Cl. CPC G06K 9/00718; G06K 9/00288; G06T 7/11; G06K 9/00771; G06K 9/00744; G06K 9/00369

(57) ABSTRACT

The present disclosure relates to an image processing method, an image processing device, and a storage medium. The method comprises: acquiring an image to be processed; acquiring, by performing an encoding processing on the image to be processed, probability distribution data of features of a person object in the image to be processed as target probability distribution data, the features being used for identifying an identity of the person object; and acquiring, by performing retrieving in a database using the target probability distribution data, images in the database having probability distribution data matching the target probability distribution data as a target image. Corresponding device, processor and storage medium are also disclosed. A target image containing a person object belonging to the same identity as the person object in the image to be processed is determined based on a similarity between the target probability distribution data of features of the person object in the image to be processed and the probability distribution data of images in the database, so as to improve the accuracy of identifying an identity of the person object in the image to be processed.

The present disclosure is a bypass continuation of and claims priority to PCT Application. No. PCT/CN2019/130420, filed on Dec. 31, 2019, which is based upon and claims the benefit of a priority of Chinese Patent Application No. 201911007069.6, filed to CNIPA on Oct. 22, 2019 and entitled “IMAGE PROCESSING METHOD, IMAGE PROCESSING DEVICE, PROCESSOR, AND STORAGE MEDIUM”, the entire contents of which are incorporated herein by reference.

### TECHNICAL FIELD

The present disclosure relates to the technical filed of image processing, particularly to an image processing method, an image processing device, a processor and a storage medium.

### BACKGROUND

At present, in order to enhance the security in work, life or social environment, camera monitoring equipment is installed in various areas to facilitate security protection according to video stream information. With the rapid growth of the number of cameras in public places, how to effectively determine an image containing a target person through massive video streams and determine track information and the like of the target person according to information on this image is of great significance.

Traditionally, a target image including a person object having the same identity as a target person is determined by matching features extracted from images in a video stream and a reference image containing the target person respectively so as to track the target person. For example: a robbery occurs in location A, the police uses images of a suspect provided by a witnesses at the scene as a reference image and determines a target image of the suspect included in the video stream through a feature-matching method.

### SUMMARY

The present disclosure provides an image processing method, an image processing device, a processor, and a storage medium to retrieve a target image including a target person from a database.

First, there is provided an image processing method comprising: acquiring an image to be processed; acquiring, by performing an encoding processing on the image to be processed, probability distribution data of features of a person object in the image to be processed as target probability distribution data, the features being used for identifying an identity of the person object; and acquiring, by performing retrieving in a database using the target probability distribution data, images in the database having probability distribution data matching the target probability distribution data as a target image.

In a second respect, there is provided an image processing device comprising: an acquiring unit configured to acquire an image to be processed; an encoding processing unit configured to acquire, by performing an encoding processing on the image to be processed, probability distribution data of features of a person object in the image to be processed as target probability distribution data, the features being used for identifying identity of the person object; and a retrieving unit configured to acquire, by performing retrieving in a database using the target probability distribution data, images in the database having probability distribution data matching the target probability distribution data as a target image.

According to a third aspect, there is provided a computer-readable storage medium having computer program including program instructions stored thereon, wherein when the program instructions are executed by a processor of an electronic device, the method as described in the above first aspect and any possible implementation thereof is caused to be executed by the processor.

It should be understood that the above general description and the following detailed description are only exemplary and explanatory rather than limiting the present disclosure.

### BRIEF DESCRIPTION OF THE DRAWINGS

In order to more clearly explain the technical solutions in the embodiments or the background technology of the present disclosure, the drawings to be used in the embodiments or the background technology of the present disclosure will be described below.

The drawings here are incorporated into and constitute a part of the specification. These drawings show embodiments consistent with the present disclosure and are used to explain the technical solutions of the present disclosure together with the description.

FIG. 1 is a schematic diagram of a hardware structure of an image processing device provided by an embodiment of the present disclosure:

FIG. 2 is a schematic flowchart of an image processing method provided by an embodiment of the present disclosure:

FIG. 3 is a schematic diagram of a probability distribution data provided by an embodiment of the present disclosure;

FIG. 4 is a schematic diagram of another probability distribution data provided by an embodiment of the present disclosure;

FIG. 5 is a schematic flowchart of another image processing method provided by an embodiment of the present disclosure;

FIG. 6 is a schematic diagram of a probability distribution data provided by an embodiment of the present disclosure;

FIG. 7 is a schematic structural diagram of a probability distribution data generation network provided by an embodiment of the present disclosure;

FIG. 8 is a schematic diagram of an image to be processed provided by an embodiment of the present disclosure;

FIG. 9 is a schematic structural diagram of a pedestrian re-identification training network provided by an embodiment of the present disclosure;

FIG. 10 is a schematic diagram of a splicing processing provided by an embodiment of the present disclosure;

FIG. 11 is a schematic flowchart of another image processing method provided by an embodiment of the present disclosure;

FIG. 12 is a schematic structural diagram of an image processing device according to an embodiment of the present disclosure:

FIG. 13 is a schematic structural diagram of another image processing device provided by an embodiment of the present disclosure;

FIG. 14 is a schematic diagram of a hardware structure of an image processing device provided by an embodiment of the present disclosure.

### DETAILED DESCRIPTION

In order to enable those skilled in the art to better understand the solutions of the present disclosure, the technical solutions in the embodiments of the present disclosure will be described clearly and completely in conjunction with the drawings in the embodiments of the present disclosure. Obviously, the described embodiments are only a part of the embodiments of the present disclosure, but not all the embodiments. According to the embodiments in the present disclosure, all other embodiments obtained by those skilled in the art without inventive labor fall within the protection scope of the present disclosure.

The terms “first” and “second” in the description and claims of the present disclosure and the above drawings are used to distinguish different objects, not to describe a specific order. In addition, the terms “comprise/include” and “have” and any variations thereof are intended to refer to any coverage without exclusions. For example, a process, method, system, product, or apparatus that includes a series of steps or units is not limited to the listed steps or units, but alternatively includes steps or units that are not listed, or alternatively also includes other steps or units inherent to these processes, methods, products or apparatuses.

It should be understood that in the present disclosure, “at least one (item)” refers to one or more, “multiple” refers to two or more, and “at least two (items)” refers to two or three and three or more, “and/or” used to describe the association relationship of associated objects indicates that there may be three kinds of relationships. For example, “A and/or B” may mean: there is only A, there is only B and there are both A and B, where A, B may be singular or plural. The character “/” generally indicates that there is “OR” relationship among the associated objects. “At least one of” or its similar expression refers to any combination of these items, including any combination of single item or plural items. For example, at least one of a, b or c may be expressed as: “a”, “b”, “c”, “a and b”, “a and c”, “b and c”, or “a and b and c”, where a, b, c may be single or plural.

“Embodiments” herein means that specific features, structures, or attributes described in connection with the embodiments may be included in at least one embodiment of the present disclosure. This term existed in various places in the description does not necessarily refer to the same embodiment, nor an independent or alternative embodiment mutually exclusive with other embodiments. Those skilled in the art understand explicitly and implicitly that the embodiments described herein can be combined with other embodiments.

The technical solution provided by the embodiments of the present disclosure may be applied to an image processing device; the image processing device may be a server or a terminal (such as a mobile phone, a tablet computer or a desktop computer); the image processing device includes a graphics processing unit (GPU); the image processing device also stores a database which contains a pedestrian image library.

FIG. 1 shows a schematic structural diagram of an image processing device according to an embodiment of the present disclosure. As shown in FIG. 1, the image processing device may include a processor 210, an external memory interface 220, an internal memory 221, a universal serial bus (USB) interface 230, a power management module 240, a network communication module 250 and a display screen 260.

It may be understood that the structure illustrated in the embodiments of the present disclosure do not constitute a specific limitation to the image processing device. In other embodiments of the present disclosure, the image processing device may include more or less components than what is shown, or combine some components, or divide some components, or have different component arrangements. The illustrated components may be implemented in hardware, software, or a combination of software and hardware.

The processor 210 may include one or more processing units, for example, the processor 210 may include an application processor (AP), a graphics processing unit (GPU), an image signal processor (ISP), a controller, a memory, a video codec, a digital signal processor (DSP), and/or a neural-network processing unit (NPU), etc. Among them, different processing units may be independent devices or may be integrated in one or more processors.

The controller may be the nerve center and command center of the image processing device; the controller may generate operation control signals according to the instruction operation code and the timing signal to complete a control of fetching instructions and executing instructions.

The processor 210 may also be provided with a memory for storing instructions and data. In some embodiments, the memory in the processor 210 is a cache memory which may store instructions or data that the processor 210 has just used or recycled.

In some embodiments, the processor 210 may include one or more interfaces. The interfaces may include an inter-integrated circuit (I2C) interface, an inter-integrated circuit sound (12S) interface, a pulse code modulation (PCM) interface, a universal asynchronous receiver/transmitter (UART) interface, a mobile industry processor interface (MIPI), a general-purpose input/output (GPIO) interface, and/or universal serial bus (USB) interface etc.

It may be understood that the interface connection relationship between the modules illustrated in the embodiments of the present disclosure is only a schematic description, and does not constitute a limitation on the structure of the image processing device. In other embodiments of the present disclosure, the image processing device may also employ different interface connection methods from that in the foregoing embodiments, or a combination of multiple interface connection methods.

The power management module 240 is connected to the external power source and receives power input from the external power source, and supplies power to the processor 210, the internal memory 221, the external memory, the display screen 250 and the like.

The image processing device realizes a display function through a GPU, a display screen 250 and the like; the GPU is a microprocessor for image processing and is connected to the display screen 250; the processor 210 may include one or more GPUs that execute program instructions to generate or change display information.

The display screen 250 is configured to display images and videos. The display screen 250 includes a display panel which may use a liquid crystal display (LCD), an organic light-emitting diode (OLED), an active-matrix organic light emitting diode (AMOLED), a flex light-emitting diode (FLED), Miniled, MicroLed, Micro-oLed, quantum dot light emitting diodes (QLED), etc. In some embodiments, the image processing device may include one or more display screens 250. For example, in the embodiment of the present disclosure, the display screen 250 may be used to display related images or videos such as target images.

The digital signal processor configured to process digital signals is used to process the digital image signals and other digital signals. For example, when the image processing device selects a frequency point, the digital signal processor is configured to perform Fourier Transform and the like on frequency point energy.

Video codec is configured to compress or decompress digital video. The image processing device may support one or more video codecs. In this way, the image processing device may play or record videos in multiple encoding formats such as moving picture experts group (MPEG)1, MPEG2, MPEG3, MPEG4.

NPU is a neural-network (NN) computing processor. By virtue of the structure of biological neural networks (for example, by virtue of the transfer mode between neurons in the human brain), NPU is able to quickly process the input information and continue to self-learn. The NPU is capable of realizing applications such as intelligent recognition of image processing devices, such as image recognition, face recognition, voice recognition and text understanding.

The external memory interface 220 may be configured to connect an external memory card (for example, a mobile hard disk) to realize storage capacity of the image processing device. The external memory card communicates with the processor 210 via the external memory interface 220 to implement data storage function. For example, in the embodiment of the present disclosure, images or videos can be stored in an external memory card, and the processor 210 of the image processing device can acquire the images stored in the external memory card via the external memory interface 220.

The internal memory 221 may be used to store computer-executable program code including instructions. The processor 210 executes instructions stored in the internal memory 221 to execute various functional applications and data processing of the image processing device. The internal memory 221 may include a storage program area and a storage data area. The storage program area may store an operating system, application program (such as image play function) necessary for at least one function, and the like. The storage data area may, for example, store data (such as images) created during use of the image processing device. In addition, the internal memory 221 may include a high-speed random-access memory and also a non-volatile memory, such as at least one magnetic disk storage device, a flash memory device, a universal flash storage (UFS). For example, in the embodiment of the present disclosure, the internal memory 221 may be configured to store multiple frames of images or videos which can be images or videos sent by the camera and received by the image processing device via the network communication module 250.

By applying the technical solution provided by the embodiments of the present disclosure, a pedestrian image library may be retrieved by using the image to be processed, and images including the person objects matching the person objects in the image to be processed can be determined from the pedestrian image library (hereinafter, the matching person objects will be referred to as a person object belonging to the same identity). For example, in the case of the image to be processed includes a person object A, it is possible to determine that the person object included in one or more target images in the pedestrian image library belongs to the same identity as the person object A by applying the technical solution provided in the embodiments of the present disclosure.

The technical solutions provided by the embodiments of the present disclosure may be applied to the field of security. In an application scenario in the field of security, the image processing device may be a server connected to one or more cameras, which can acquire the video stream collected by each camera in real time. The images including people objects among the images in the captured video stream may be used to construct a pedestrian image library. Relevant managers may acquire a target image including a person object belonging to the same identity as the person object (hereinafter referred to as a target person object) in the image to be processed by performing retrieving in the pedestrian image library using the image to be processed, and thereby achieving the effect of tracking the target person object according to the target image. For example, a robbery occurred in location A, a witness John provided the police with an image a of the suspect and the police may use a to retrieve the pedestrian image library to obtain all images containing the suspect. After acquiring all the images containing the suspect in the pedestrian image library, the police may track and arrest the suspect according to information of these images.

The technical solutions provided by the embodiments of the present disclosure will be described in detail below in conjunction with the drawings in the embodiments of the present disclosure.

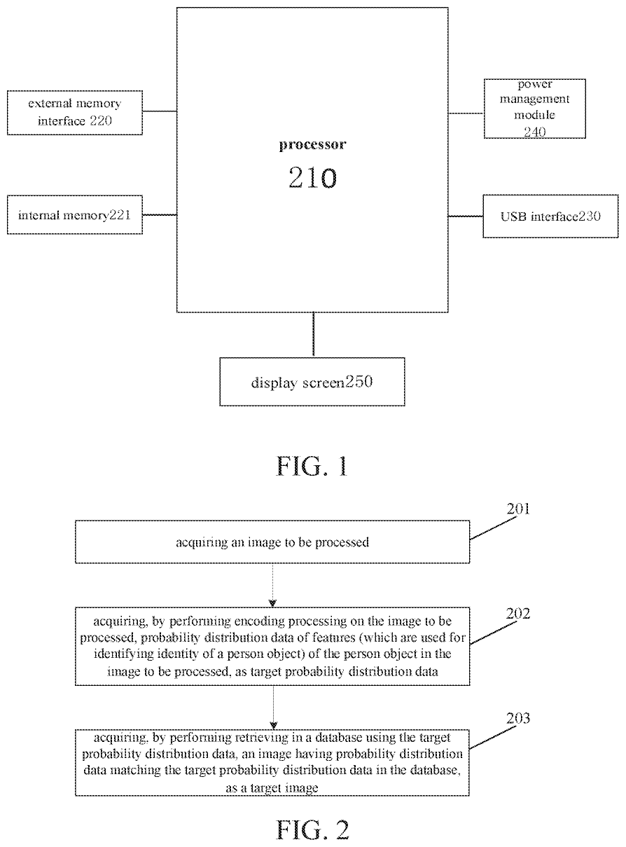

By referring to FIG. 2 which is a schematic flowchart of an image processing method provided by embodiment (I) of the present disclosure, the execution main body of this embodiment is the above-mentioned image processing device.

201. Acquiring an image to be processed

In the embodiment of the present disclosure, the image to be processed includes a person object, and the image to be processed may only include a face without trunk and limbs (hereinafter referred to as a body), only include the body, does not include the body, or only include the lower or upper limbs. The present disclosure does not limit the body area specifically included in the image to be processed.

The method for acquiring the image to be processed may be receiving the image to be processed input by the user via an input component which includes a keyboard, a mouse, a touch screen, a touch pad, an audio inputting device and the like, or receiving an image to be processed sent by a terminal which includes a mobile phone, a computer, a tablet computer, a server and the like.

202. Acquiring, by performing an encoding processing on the image to be processed, probability distribution data of features (which are used for identifying identity of a person object) of the person object in the image to be processed, as target probability distribution data

In this embodiment of the present disclosure, the encoding processing on the image to be processed can be implementing by performing a feature extraction processing and a non-linear transformation on the image to be processed in sequence. Alternatively, the feature extraction processing may be a convolution processing, a pooling processing, a downsampling processing, or any one or more combinations of the convolution processing, the pooling processing and the downsampling processing.

It is possible to obtain a feature vector (i.e., first feature data) containing information on the image to be processed by performing the feature extraction processing on the image to be processed.

In one possible implementation, the first feature data may be obtained by performing a feature extraction processing on the image to be processed through the deep neural network. The deep neural network includes multiple convolutional layers, and the deep neural network has been trained to acquire an ability of extracting content information in the image to be processed. By performing a convolution processing on the image to be processed through multiple convolution layers in the deep neural network, the content information in the image to be processed can be extracted to acquire the first feature data.

In the embodiment of the present disclosure, features of the person object are used for identifying the identity of the person object, and features of the person object include clothing attributes, appearance features and variable features of the person object. The clothing attributes include at least one of the features of all articles decorating the human body (such as color of jacket, color of pants, pants length, hat style, color of shoes, holding up an umbrella or not, bag type, wearing a mask or not, mask color). The appearance features include body shape, gender, hairstyle, color of hair, age, wearing glasses or not, and holding something in the arms or not. The variable features include posture, angle of view, and stride.

For example (Example 1), the types of the color of jacket, color of pants, color of shoes or color of hair may include black, white, red, orange, yellow, green, blue, purple and brown; the types of the pants length may include trousers, shorts and skirts; the types of the hat style may include bare-head, baseball cap, peaked cap, flat-brimmed hat, fisherman hat, beret and bowler; holding up an umbrella or not may include holding up an umbrella and not holding up an umbrella; the hairstyle may include shoulder-length hair, short hair, shaved head, bald head; the posture may include riding, standing, walking, running, lying down and lying flat; the angle of view refers to the angle of the front of the person object in the image relative to the camera. The types of the angle of view includes front, side and back; the stride refers to the size of stride when the person object is walking, and the stride size may be expressed by distance, such as 0.3 m, 0.4 m, 0.5 m and 0.6 m.

It is possible to obtain the probability distribution data of features of the person object in the image to be processed, i.e., the target probability distribution data by performing the first non-linear transformation on the first feature data. The probability distribution data of the features of a person object indicates the probability that the person object has different features or the probability that the person object appears with different features.

Then taking another example (Example 2) following Example 1, if a person a often wears a blue jacket, in the probability distribution data of the features of the person a, the probability that the color of the jacket is blue is larger (such as 0.7), while in the probability distribution data of the features of the person a, the probability that the jacket is in other colors is lower (for example, the probability value that the jacket is in red is 0.1 and the probability value that the jacket is in white is 0.15); if a person b often rides and rarely walks, in the probability distribution data of the features of the person b, the probability value of the riding posture is greater than the probability value of other postures (for example, the probability value of riding posture is 0.6, the probability value of standing posture is 0.1, the probability value of walking posture is 0.2 and the probability of lying down posture is 0.05); if images of the person c collected by the camera is mostly back images, in the probability distribution data of the features of the person c, the probability value that the angle of view is the back is greater than the probability that the angle of view is the front and the probability value that the angle of view is the side (for example, the probability value of the back is 0.6, the probability value of the front is 0.2 and the probability value of the side is 0.2).

In the embodiments of the present disclosure, the probability distribution data of features of the person object includes data of multiple dimensions, data of all dimensions conforms to the same distribution, and data of each dimension contains all feature information, that is, data of each dimension contains the probability that the person object has any of the above features and the probability that the person object appears with different features.

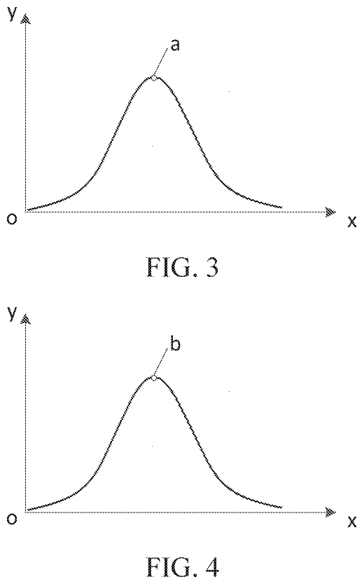

Then taking another example (Example 3) following Example 2, assuming that the feature probability distribution data of the person c contains data of two dimensions, FIG. 3 shows the data of the first dimension and FIG. 4 shows the data of the second dimension. Point a in the data of the first dimension indicates that; the probability that person c wears a white jacket is 0.4; the probability that person c wears black pants is 0.7; the probability that person c wears trousers is 0.7; the probability that person c does not wear a hat is 0.8; the probability that person c wears black shoes is 0.7; the probability that person c does not hold up an umbrella is 0.6; the probability that person c does not hold a bag in hand is 0.3; the probability that person c does not wear a mask is 0.8; the probability that person c is in a normal size is 0.6; the probability that person c is a male is 0.8; the probability that person c is in a short hair is 0.7; the probability that person c has a black hair is 0.8; the probability that the age of the person c is between 30 and 40 is 0.7; the probability that person c does not wear glasses is 0.4; the probability that person c holds something in the arms is 0.2; the probability that person c is walking is 0.6; the probability that the angle of view in which person c appears is a back-view is 0.5; and the probability that the stride of the person c is 0.5 m is 0.8. FIG. 4 shows the data of the second dimension. Point b in the data of the second dimension indicates that; the probability that person c wears a black jacket is 0.4; the probability that person c wears white pants is 0.1; the probability that person c wears shorts is 0.1; the probability that person c wears a hat is 0.1; the probability that person c wears white shoes is 0.1; the probability that person c holds up an umbrella is 0.2; the probability that person c holds a bag in hand is 0.5; the probability that person c wears a mask is 0.1; the probability that person c is in a thinner size is 0.1; the probability that person c is a female is 0.1; the probability that person c is in a long hair is 0.2; the probability that person c has a gold hair is 0.1; the probability that the age of the person c is between 20 and 30 is 0.2; the probability that person c wears glasses is 0.5; the probability that person c does not hold something in the arms is 0.3; the probability that person c is riding is 0.3; the probability that the angle of view in which person c appears is a side-view is 0.2; and the probability that the stride of the person c is 0.6 m is 0.1.

It can be seen from Example 3 that data of each dimension contains all the feature information on the person object, but the contents of the feature information contained in the data of different dimensions are different, which indicates that the probability values of different features are different.

In the embodiment of the present disclosure, although the probability distribution data of the features of each person object includes data of multiple dimensions, and the data of each dimension contains all the feature information on the person object, the features described by data of each dimension focus on different aspects.

Then taking another example (Example 4) following Example 2, assuming that the probability distribution data of the features of the person b contains data of 100 dimensions, in each of the data of the first 20 dimensions, a proportion of information of clothing attributes in information contained in each dimension is greater than that of information of appearance features and variable features in the information contained in each dimension, so the data of the first 20 dimensions is more focused on describing clothing attributes of the person b; in each of the data of 21^{st} to 50^{th} dimensions, a proportion of the information of appearance features in information contained in each dimension is greater than that of the information of clothing attributes and variable features in the information contained in each dimension, so the data of the 21^{st} to 50^{th} dimensions is more focused on describing appearance features of the person b; in each of the data of 50^{th} to 100^{th} dimensions, a proportion of the information of variable features in information contained in each dimension is greater than that of the information of clothing attributes and appearance features in the information contained in each dimension, so the data of the 50^{th} to 100^{th} dimensions is more focused on describing appearance features of the person b.

In a possible implementation, the target probability distribution data may be obtained by encoding the first feature data. The target probability distribution data may be used to indicate the probability that the person object in the image to be processed has different features or the probability that the person object appears with different features, and the features in the target probability distribution data may be used for identifying the identity of the person object in the image to be processed. The above encoding process is a non-linear process, and alternatively, the encoding process may include a fully connected layer (FCL) process and an activation process and may also be implemented by the convolution processing or the pooling processing. The present disclosure does not make any specific limitation on this.

203. Acquiring, by performing retrieving in a database using the target probability distribution data, an image having probability distribution data matching the target probability distribution data in the database, as a target image

In the embodiment of the present disclosure, as described above, the database includes a pedestrian image library, and the mean data of each image (hereinafter referred to as a reference image) in the pedestrian image library includes one person object. In addition, the database also contains the probability distribution data (hereinafter referred to as reference probability distribution data) of the person object (hereinafter referred to as reference person object) in each image in the pedestrian image library, that is, each image in the pedestrian image library has a probability distribution data.

As described above, the probability distribution data of the features of each person object contains data of multiple dimensions, and the features described by the data of different dimensions focus on different aspects. In the embodiment of the present disclosure, the number of dimensions of the reference probability distribution data and the number of dimensions of the target probability distribution data are the same, and the features described in the same dimension are the same.

For example, both the target probability distribution data and the reference probability distribution data contain 1024-dimensional data. In the target probability distribution data and the reference probability distribution data, the first dimensional data, the second dimensional data, the third dimensional data, . . . , the 500^{th} dimensional data are all focused on describing the clothing attributes, the 501^{th} dimensional data, the 502^{th} dimensional data, the 503^{rd} dimensional data, . . . , the 900^{th} dimensional data are all focused on describing appearance features, the 901^{th} dimensional data, the 902^{th} dimensional data, the 903^{th} dimensional data, . . . , the 1024^{th} dimensional data are all focused on describing the variable features.

A similarity between the target probability distribution data and the reference probability distribution data may be determined according to a similarity between information contained in one dimension in the target probability distribution data and information contained in the same dimension in the reference probability distribution data.

In a possible implementation, the similarity between the target probability distribution data and the reference probability distribution data may be determined by calculating the wasserstein metric between the target probability distribution data and the reference probability distribution data. The smaller the wasserstein metric is, the greater the similarity between the target probability distribution data and the reference probability distribution data is.

In another possible implementation, the similarity between the target probability distribution data and the reference probability distribution data may be determined by calculating the Euclidean distance between the target probability distribution data and the reference probability distribution data. The smaller the Euclidean distance is, the greater the similarity between the target probability distribution data and the reference probability distribution data is.

In yet another possible implementation, the similarity between the target probability distribution data and the reference probability distribution data may be determined by calculating the JS divergence (Jensen-Shannon divergence) between the target probability distribution data and the reference probability distribution data. The smaller the JS divergence is, the greater the similarity between the target probability distribution data and the reference probability distribution data is.

The greater the similarity between the target probability distribution data and the reference probability distribution data is, the greater the probability that the target person object and the reference person object belong to the same identity is. Therefore, the target image may be determined according to the similarity between the target probability distribution data and the probability distribution data of each image in the pedestrian image library.

Alternatively, the similarity between the target probability distribution data and the reference probability distribution data is used as the similarity between the target person object and the reference person object, and then the reference image in which similarity is greater than or equal to the similarity threshold is used as the target image.

For example, the pedestrian image library contains three reference images, namely a, b, c, d, and e. The similarity between the probability distribution data of a and the target probability distribution data is 78%, the similarity between the probability distribution data of b and the target probability distribution data is 92%, the similarity between the probability distribution data of c and the target probability distribution data is 87%, similarity between the probability distribution data of d and the target probability distribution data is 67%, and the similarity between the probability distribution data of e and the target probability distribution data is 81%. Assuming that the similarity threshold is 80%, the similarities greater than or equal to the threshold are 92%, 87% and 81%, the image corresponding to the similarity 92% is b, the image corresponding to the similarity 87% is c, and the image corresponding to the similarity 81% is e, that is, the images b, c, e are the target images.

Alternatively, if multiple target images are obtained, confidence of the target image may be determined according to the similarity, and the target images may be sorted in an order of confidence from the largest to the smallest such that the user can determine the identity of the target person object according to the similarity of the target images. The confidence of the target image are positively correlated with the similarity, and the confidence of the target image characterizes the confidence that the person object in the target image and the target person object belong to the same identity. For example, there are three target images, namely, a, b, c, and the similarity between the reference person object in the target image a and the target person object is 90%, the similarity between the reference person object in the target image b and the target person object is 93%, the similarity between the reference person object in the target image c and the target person object is 88%, then it is possible to set the confidence of the target image a to 0.9, the confidence of the target image b to 0.93 and the confidence of the target image c to 0.88. The sequence obtained after sorting the target images according to the confidences is b→a→c.

The target probability distribution data obtained by the technical solution provided in the embodiments of the present disclosure includes various feature information of the person object in the image to be processed.

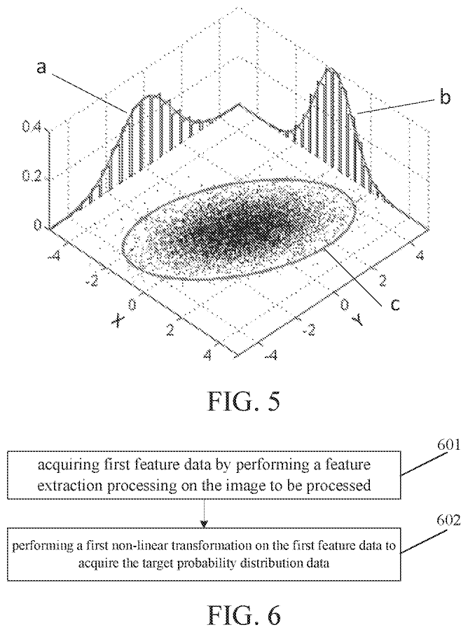

For example, by referring to FIG. 5, assuming that the data of the first dimension in the first feature data is a, the data of the second dimension is b and the information contained in a is used for describing the probability that the person objects in the image to be processed appears in different postures, the information contained in b is used for describing the probability that the person objects in the image to be processed wear jackets in different colors. It is possible to obtain a target probability distribution by encoding the first feature data through the method provided in this embodiment, and obtain a joint probability distribution data c based on a and b. That is, it is possible to determine one point on c according to any point on a and any point on b, and then obtain, according to the points contained in c, a probability distribution data that not only describes the probability that the person objects in the image to be processed appears in different postures but also describes the probability that the person objects in the image to be processed wear jackets in different colors.

It should be understood that in the feature vector of the image to be processed (i.e. the first feature data), the variable features are included in the clothing attributes and the appearance feature. That is, the information contained in the variable features is not used when it is determined whether the target person object and the reference person object belong to the same identity according to the similarity between the first feature data and feature vectors of the reference image.

For example, it is assumed that the person object a wears a blue jacket, appears in a riding posture and is in a front-view in the image a, while the person object a wears a blue jacket, appears in a standing posture and is in a back-view in the image b. When whether the person object in the image a and the person object in the image b belong to the same identity is identified by the matching degree between the feature vector of the image a and the feature vector of the image b, only the clothing attributes (i.e. blue jacket) of the person object but not the posture information and angle of view information will be used. Since the posture information and the angle of view information of the person object in the image a is quite different from the posture information and the angle of view information in the image b, when whether the person object in the image a and the person object in the image b belong to the same identity is identified by the matching degree between the feature vector of the image a and the feature vector of the image b, the recognition accuracy will be reduced by using the posture information and the angle of view information of the person object (for example, identifying the person object in the image a and the person object in the image b as person objects not belonging to the same identity).

The technical solution provided by the embodiments of the present disclosure encodes the first feature data to acquire the target probability distribution data, so as to decouple the variable features from the clothing attributes and the appearance features (as described in Example 4, the features described by data in different dimensions focus on different aspects).

Since both the target probability distribution data and the reference probability distribution data contain variable features, the information contained in the variable features will be used when the similarity between the target probability distribution data and the reference probability distribution data is determined according to the similarity of the information contained in the same dimension in the target probability distribution data and the reference probability distribution data. That is to say, the embodiments of the present disclosure utilize the information contained in the variable features when determining the identity of the target person object. It is benefit for the technical solution provided by the embodiments of the present disclosure to improve accuracy of identifying identity of the target person object by determining the target person object using information contained in the clothing attributes and the appearance feature while determining the identity of the target person object using information contained in the variable features.

In this embodiment, the first feature data is obtained by performing a feature extraction processing on the image to be processed to extract the feature information of the person object in the image to be processed. Then, it is possible to obtain the target probability distribution data of features of the person object in the image to be processed based on the first feature data, so as to decouple the information contained in the variable features of the first feature data from the clothing attributes and the appearance features. In this way, it is possible to use information contained in the variable features during the process of determining the similarity between the target probability distribution data and the reference probability distribution data in the database, so as to further improve accuracy of determining images including a person object belonging to the same identity as the person object in the image to be processed based on the similarity, that is, improve accuracy of identifying the identity of the person objects in the image to be processed.

As described above, the technical solution provided by the embodiments of the present disclosure acquires the target probability distribution data by encoding the first feature data. The method for acquiring the target probability distribution data will be described in detail as follows.

Please refer to FIG. 6 which shows a schematic flowchart of a possible implementation of 202 provided in Embodiment II of the present disclosure.

601. Acquiring first feature data by performing a feature extraction processing on the image to be processed.

Please refer to 202 and the redundant description here will be omitted.

602. Performing a first non-linear transformation on the first feature data to acquire the target probability distribution data.

The capability of learning complex mapping from data by the feature extraction processing described above is weak, that is, complex type data such as probability distribution data cannot be processed only by the feature extraction processing. Therefore, it is necessary to perform a second non-linear transformation on the first feature data to process complex data such as probability distribution data and acquire a second feature data.

In a possible implementation, it is possible to obtain the second feature data by processing the first feature data through FCL and non-linear activation function in sequence. Alternatively, the aforementioned non-linear activation function is a rectified linear unit (ReLU).

In another possible implementation, it is possible to obtain the second feature data by performing a convolution processing and a pooling processing on the first feature data in sequence. The process of the convolution processing is as follows: performing the convolution processing on the first feature data, that is, convolution kernel is used to slide on the first feature data, the values of the elements in the first feature data are multiplied with the values of all elements in the convolution kernel respectively, then the sum of all products obtained after the multiplication is considered as the value of this element, and finally all the elements in the input data of the coding layer complete slide operation, so as to acquire the data after the convolution processing. The pooling process may be average pooling or maximum pooling. In one example, it is assumed that the size of the data obtained by the convolution processing is h*w, wherein h and w indicate the length and width of the data obtained by the convolution processing respectively. When the target size of the second feature data to be obtained is H*W (H denotes length and W denotes width), the data obtained by the convolution process may be divided into H*W grids, so that the size of each grid is (h/H)*(w/W), and then the average or maximum value of the pixels in each grid is calculated to obtain the second feature data of the target size.

Since the data before the non-linear transformation and the data after the non-linear transformation are in a one-to-one mapping relationship, only the feature data but not probability distribution data can be obtained if the non-linear transformation is directly performed on the second feature data. In this way, in the feature data obtained after the non-linear transformation is performed on the second feature data, the variable features are contained in the clothing attributes and appearance features, and thus the variable features cannot be decoupled from the clothing attributes and appearance features.

Therefore, in this embodiment, a third non-linear transformation is performed on the second feature data to acquire a first processing result as mean data, and a fourth non-linear transformation is performed on the second feature data to acquire a second processing result as variance data. Then, it is possible to determine the probability distribution data, i.e. the target probability distribution data according to the mean data and the variance data.

Alternatively, both the third non-linear transformation and the fourth non-linear transformation may be implemented through a fully connected layer.

In this embodiment, the first feature data is non-linearly transformed to acquire mean data and variance data, and the target probability distribution data is obtained through the mean data and variance data.

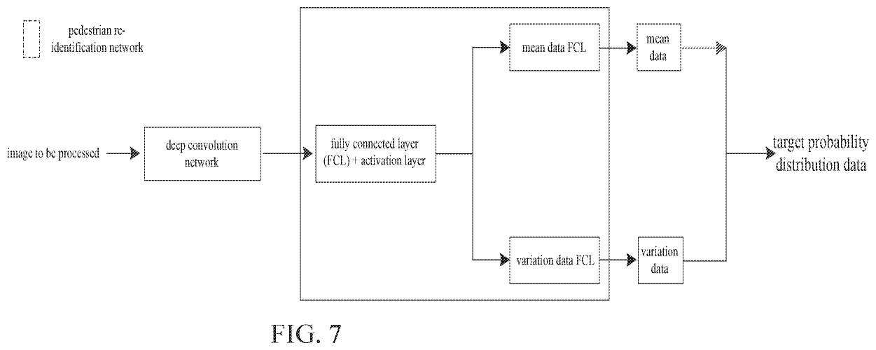

The embodiment (I) and the embodiment (II) describe the method for acquiring the probability distribution of features of the person object in the image to be processed. The embodiment of the present disclosure also provides a probability distribution data generation network for implementing the method in the embodiment (I) and embodiment (II). FIG. 7 shows a structural diagram of a probability distribution data generation network provided by Embodiment (III) of the present disclosure.

As shown in FIG. 7, the probability distribution data generation network provided by the embodiment of the present disclosure includes a deep convolution network and a pedestrian re-identification network. The deep convolution network is configured to perform a feature extraction processing on the image to be processed to acquire a feature vector of the image to be processed (i.e., first feature data). The first feature data is input to the pedestrian re-recognition network. The process of the fully connected layer and the process of the activation layer are performed on the first feature data in sequence, so as to perform a non-linear transformation on the first feature data. Then, by processing the output data of the activation layer, it is possible to obtain the probability distribution data of the features of the person object in the image to be processed. The aforementioned deep convolution network includes multiple layers of convolutional layers and the aforementioned activation layer includes non-linear activation functions such as sigmoid and ReLU.

Since the capability of obtaining the target probability distribution data based on the feature vector (first feature data) of the image to be processed by the pedestrian re-recognition network is learned through training, if the output data of the activation layer is directly processed to acquire the target output data, the pedestrian re-recognition network can only learn the mapping relationship from the output data of the activation layer to the target output data through training, and the mapping relationship is a one-to-one mapping. In this way, it is impossible to obtain the target probability distribution data according to the obtained target output data, that is, only feature vectors (hereinafter referred to as target feature vectors) can be obtained based on the target output data. In the target feature vectors, the variable features are also contained in the clothing attributes and appearance features, and then the information contained in the variable features will be not used when it is determined whether the target person object and the reference person object belong to the same identity according to the similarity between the target feature vectors and feature vectors of the reference image.

Based on the above considerations, the pedestrian re-identification network provided by the embodiment of the present disclosure processes the output data of the activation layer through the mean data fully connected layer and the variance data fully connected layer to acquire mean data and variance data. In this way, the pedestrian re-recognition network can learn the mapping relationship from the output data of the activation layer to the mean data and the mapping relationship from the output data of the activation layer to the variance data during the training process, and then the target probability distribution data can be obtained based on the mean data and the variance data.

The target probability distribution data is obtained based on the first feature data to decouple variable features from clothing attributes and appearance features, and then the information contained in the variable features can be used to improve the accuracy of identifying identity of the target person objects when determining whether the target person object and the reference person object belong to the same identity.

By processing the first feature data via the pedestrian re-identification network to obtain the target feature data, it is possible to acquire the probability distribution data of the features of the target person object according to the feature vectors of the image to be processed. The target probability distribution data contains all the feature information of the target person object, whereas the image to be processed only contains a part of the feature information of the target person object.

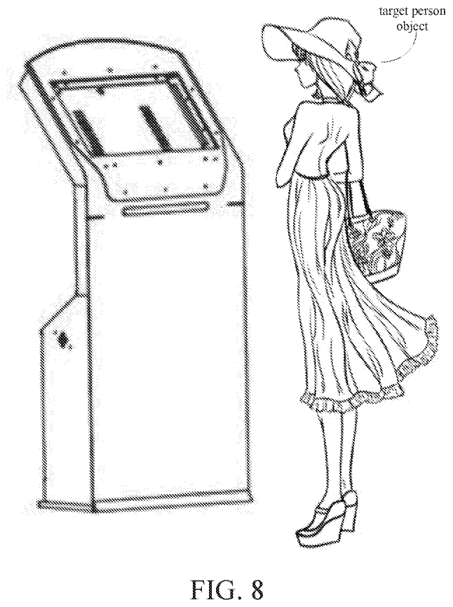

For example (Example 4), in the image to be processed shown in FIG. 8, the target person object a is querying information in front of a query machine. The features of the target person object in the image to be processed include: off-white bowler hat, long black hair, white long skirt, white handbag in hand, no mask, off-white shoes, normal body shape, female, 20 to 25 years old, no glasses, standing posture and side-view. The pedestrian re-identification network provided by the embodiment of the present disclosure processes the feature vectors of the image to be processed to acquire the probability distribution data of the feature of a, and the probability distribution data of the feature of a includes all the feature information of a: a probability that a does not wear a hat, a probability that a wears a white hat, a probability that a wears a gray flat-brimmed hat, a probability that a wears a pink jacket, a probability that a wears black pants, a probability that a wears white shoes, a probability that a wears glasses, a probability that a wears a mask, a probability that a does not hold a handbag, a probability that a is in a thinner size, a probability that a is a female, a probability that the age of a is between 25 and 30, a probability that a appears in a walking posture, a probability that a appears in a front-view, a probability that a stride of a is 0.4 meters, and so on.

That is, the pedestrian re-recognition network has the capability of obtaining the probability distribution data of the features of the target person object in the image to be processed based on any one of the image to be processed, thereby implementing a prediction from “special” (i.e. partial feature information of target person object) to “general” (i.e. all the feature information of the target person object). When all the feature information of the target person object are known, these feature information may be used for identifying the identity of the target person object accurately.

The capability of the above prediction implemented by the pedestrian re-recognition network is learned through training. The training process of the pedestrian re-recognition network will be explained in detail below.

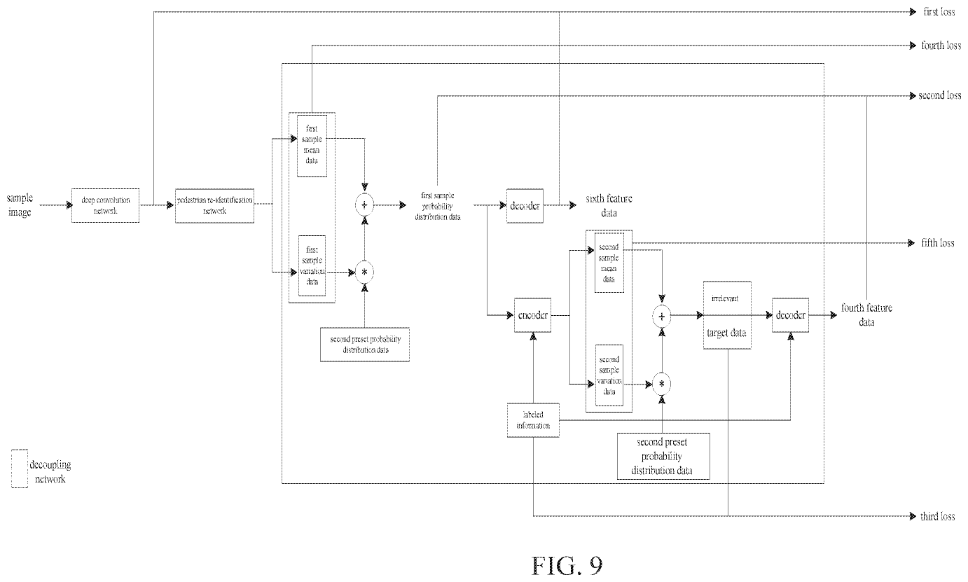

Please refer to FIG. 9. FIG. 9 shows a pedestrian re-identification training network provided by embodiment (IV) of the present disclosure. The training network is configured to train the pedestrian re-identification network provided in embodiment (IV). It should be understood that, in this embodiment, the deep convolution network is pre-trained and the parameters of the deep convolution network will not be updated during the subsequent adjustment of the parameters of the pedestrian re-identification training network.

As shown in FIG. 9, the pedestrian re-identification network includes a deep convolution network, a pedestrian re-identification network and a decoupling network. The sample image for training is input to the deep convolution network to acquire a feature vector of the sample image (i.e. the third feature vector), and then the third feature data is processed through the pedestrian re-recognition network to acquire the first sample mean data and the first sample variance data, and the first sample mean data and the first sample variance data are used as the input of the decoupling network. Then the first sample mean data and the first sample variance data are processed through the decoupling network to acquire a first loss, a second loss, a third loss, a fourth loss and a fifth loss, and parameters of the pedestrian re-identification training network are adjusted based on the above five losses, that is, a reverse gradient propagation is performed on the pedestrian re-identification training network based on the above five losses to update parameters of the pedestrian re-identification training network, and then to complete training of the pedestrian re-identification network.

To enable the gradient to be successfully transmitted back to the pedestrian re-recognition network, it is necessary to ensure that it is derivable in the pedestrian re-recognition training network. Therefore, the decoupling network first samples from the first sample mean data and the first sample variance data to acquire first sample probability distribution data that conforms to the first preset probability distribution data. The first preset probability distribution data is a continuous probability distribution data, that is, the first sample probability distribution data is a continuous probability distribution data. In this way, the gradient may be transmitted back to the pedestrian re-recognition network. Alternatively, the first preset probability distribution data is Gaussian distribution.

In a possible implementation, the first sample probability distribution data conforming to the first preset probability distribution data may be obtained by sampling from the first sample mean data and the first sample variance data through the multi-parameter sampling technique. That is, the first sample variance data and the preset probability distribution data are multiplied to acquire a fifth feature data, and then the sum of the fifth feature data and the first sample mean data is obtained as the first sample probability distribution data. Alternatively, the preset probability distribution data is normally distributed.

It should be understood that, in the above possible implementations, the number of dimensions of the data contained in the first sample mean data, the first sample variance data and the preset probability distribution data are the same. If the first sample mean data, the first sample variance data and the preset probability distribution data contain data of multiple dimensions, the data of the first sample variance data is multiplied with the data of the same dimension in the preset probability distribution data, and then the result obtained by the multiplication is added to the data of the same dimension in the first sample mean data to acquire data of one dimension in the first sample probability distribution data.

For example, the first sample mean data, the first sample variance data and the preset probability distribution data all contain data of two dimensions. The data of the first dimension in the first sample mean data is multiplied with the data of the first dimension in the preset distribution data to acquire a first multiplied data, and then the first multiplied data is add to the data of the first dimension in the first sample variance data to acquire a result data of the first dimension. The data of the second dimension in the first sample mean data is multiplied with the data of the second dimension in the preset probability distribution data to acquire a second multiplied data, and then the second multiplied data is added to the data of the second dimension in the first sample variance data to acquire a result data of the second dimension. The first sample probability distribution data is obtained according to the result data of the first dimension and the result data of the second dimension. The data of the first dimension in the first sample probability distribution data is the result data of the first dimension, and the data of the first dimension is the result data of the first dimension.

Then, a decoder decodes the first sample probability distribution data to acquire one feature vector (sixth feature data). The decoding process may be any of the following: a deconvolution processing, a bilinear interpolation processing, and a de-pooling processing.

Then, the first loss is determined according to the difference between the third feature data and the sixth feature data. The difference between the third feature data and the sixth feature data is positively correlated with the first loss. The smaller the difference between the third feature data and the sixth feature data is, the smaller the difference between the identity of the person object characterized by the third feature data and the identity of the person object characterized by the sixth feature data is. The sixth feature data is obtained by performing a decoding processing to the first sample probability distribution data. The smaller the difference between the sixth feature data and the third feature data is, the smaller the difference between the identity of the person object characterized by the first sample probability distribution data and the identity of the person object characterized by the third feature data is. The feature information contained in the first sample probability distribution data sampled from the first sample mean data and the first sample variance data is the same as the feature information contained in the probability distribution data determined from the first sample mean data and the first sample variance data. That is, the identity of the person object characterized by the first sample probability distribution data is the same as the identity of the person object characterized by the probability distribution data determined from the first sample mean data and the first sample variance data. Therefore, the smaller the difference between the sixth feature data and the third feature data is, the smaller the difference between the identity of the person object characterized by the probability distribution data determined from the first sample mean data and the first sample variance data and the identity of the person object characterized by the third feature data is, and further the smaller the difference between the identity of the person object characterized by the first sample mean data and the first sample variance data and the identity of the person object characterized by the third feature data is, the first sample mean data being obtained by processing the output data of the activation layer through the mean data fully connected layer by the pedestrian re-identification network, the first sample variance data being obtained by processing the output data of the activation layer through the variance data fully connected layer by the pedestrian re-identification network. That is, it is possible to obtain the probability distribution data of features of the person object in the sample image by processing the third feature data of the sample image by the pedestrian re-identification network.

In a possible implementation, the first loss may be determined by calculating the mean square error between the third feature data and the sixth feature data.

As described above, to enable the pedestrian re-recognition network to acquire the probability distribution data of the features of the target person object according to the first feature data, the pedestrian re-recognition network acquires a mean data and a variance data through the mean data fully connected layer and the variance data fully connected layer respectively and determines the target probability distribution data according to the mean data and the variance data. Thus, the smaller the difference between the respective probability distribution data determined by the mean data and the variance data of the person objects belonging to the same identity is and the greater difference between the respective probability distribution data determined by the mean data and the variance data of the person objects belonging to different identities is, the better the effect of determining the identity of the person object by using the target probability distribution data is. Therefore, in this embodiment, the fourth loss is used to measure the difference between the identities of the person objects determined by the first sample mean data and the first sample variance data and the labeled data of the sample image, and the fourth loss is positively correlated with the difference.

In a possible implementation, the fourth loss [symbol] ₄ may be calculated by the following formula:

[symbol]

₄=max(dₚ(z)−dₙ(z)+α·0) Formula (1)

wherein dₚ(z) is a distance between the respective first sample probability distribution data of sample images containing the same person object, and dₙ(z) is a distance between the respective first sample probability distribution data of the sample images containing different person objects, α is a positive number less than 1 and alternatively α=0.3.

For example, it is assumed that the training data includes ten sample images, each of the five sample images contain only one person object, and these five sample images have three person objects with different identities. The person objects included in both the images a and c are Tom, the person objects included in both the images b and d are John, and the person objects included in the image e are Jerry. The probability distribution of Tom's features in image a is A, the probability distribution of John's features in the image b is B, the probability distribution of Tom's features in the image c is C, the probability distribution of John's features in the image d is D, and the probability distribution of Jerry's features in the image e is E. The distance between A and B is calculated and recorded as AB. The distance between A and C is calculated and recorded as AC. The distance between A and D is calculated and recorded as AD. The distance between A and E is calculated and recorded as AE. The distance between B and C is calculated and recorded as BC. The distance between B and D is calculated and recorded as BD. The distance between B and E is calculated and recorded as BE. The distance between C and D is calculated and recorded as CD. The distance between C and E is calculated and recorded as CE. The distance between D and E is calculated and recorded as DE. Then dₚ(z)=AC+BD, dₙ(z)=AB+AD+AE+BC+BE+CD+CE+DE. The fourth loss may be determined according to the formula (1).

After acquiring the first sample probability distribution data, the first sample probability distribution data and the labeled data of the sample image may also be spliced, and the spliced data may be input to an encoder for encoding processing. For the configuration of the encoder, please refer to the pedestrian re-recognition network. The identity information in the first sample probability distribution data is removed by performing encoding processing to the spliced data, so as to obtain a second sample mean data and a second sample variance data.

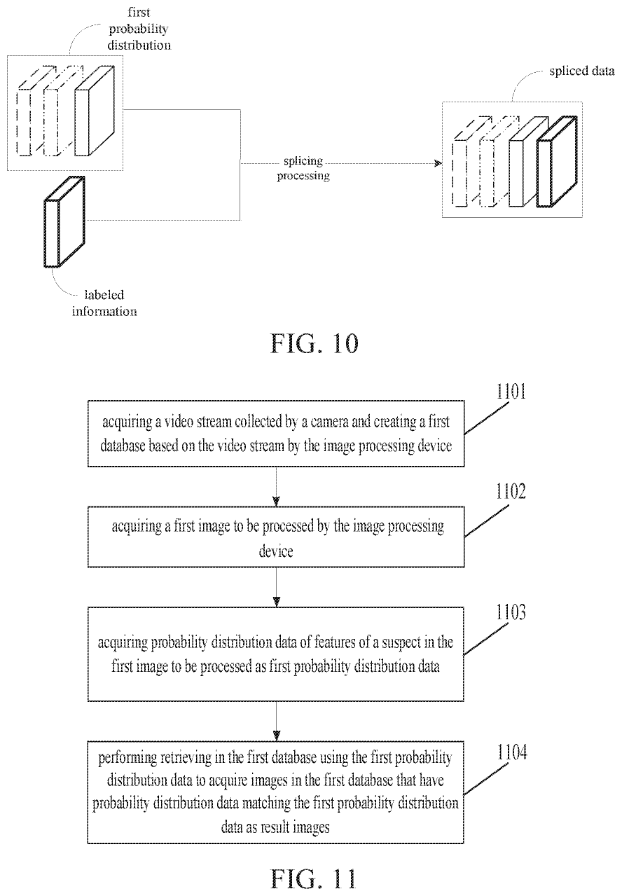

The above splicing process superimposes the first sample probability distribution data and the labeled data on the channel dimension. For example, as shown in FIG. 10, the first sample probability distribution data includes data of three dimensions, the labeled data includes data of one dimension, and the spliced data obtained by splicing the first sample probability distribution data and the labeled data contains data of four dimensions.

The above first sample probability distribution data is the probability distribution data of features of the person objects in the sample image (hereinafter referred to as sample person objects). That is, the first sample probability distribution data contains the identity information of the sample person objects, and the identity information of the sample person object in the first sample probability distribution data may be understood as that a label of the identity of the sample person object is added to the first sample probability distribution data. Example 5 describes removing the identity information of the sample person objects in the first sample probability distribution data. In the Example 5, assuming that the person object in the sample image is b, the first sample probability distribution data includes all feature information of b, such as the probability that b does not wear a hat, the probability that b wears a white hat, the probability that b wears a gray flat-brimmed hat, the probability that b wears a pink jacket, the probability that b wears black pants, the probability that b wears white shoes, the probability that b wears glasses, the probability that b wears a mask, the probability that b does not hold a handbag, the probability that b is in a thinner size, the probability that b is a female, the probability that the age of b is between 25 and 30, the probability that b appears in a walking posture, the probability that b appears in a front-view, and the probability that the stride of b is a 0.4 meters. The probability distribution data determined by the second sample mean data and the second sample variation data obtained after removing identity information of b from the first sample probability distribution data includes all the following feature information after removing identity information of b; the probability of not wearing a hat, the probability of wearing a white hat, the probability of wearing a gray flat-brimmed hat, the probability of wearing a pink jacket, the probability of wearing black pants, the probability of wearing white shoes, the probability of wearing glasses, the probability of wearing a mask, the probability of not holding a handbag, the probability of being in a thinner size, the probability of being a female, the probability of having an age between 25 and 30, the probability of appearing in a walking posture, a probability of appearing in a front-view, a probability of having a stride of 0.4 meters, and so on.

Alternatively, the labeled data in the sample image is used to distinguish the identities of the person objects. For example, the labeled data of the person object Tom is 1, the labeled data of the person object John is 2, and the labeled data of the person object Jerry is 3. Obviously, the values of these labeled data cannot be continuous but discrete and disordered. Thus, before processing the labeled data, the labeled data of the sample image needs to be encoded, that is, the labeled data is encoded to digitize the features of the labeled data. In a possible implementation, one-hot encoding is performed on the labeled data to acquire the encoded data, that is, one-hot vector. After the encoded labeled data is obtained, the encoded data and the first sample probability distribution data are spliced to acquire the spliced probability distribution data, and the spliced probability distribution data is encoded to acquire a second sample probability distribution data.

There is often a certain correlation between some features of people. For example (Example 6), men seldom wear pink jacket generally, and thus, when a person object wears a pink jacket, the probability that the person object is a male is lower and the probability that the person object is a female is higher. In addition, the pedestrian re-recognition network will learn deeper semantic information during the training process. For example (Example 7), the training set for training contains images in a front-view of the person object c, images in a side-view of the person object c, and images in a back-view of the person object c. The pedestrian re-recognition network can be based on an association among the three different angles of view of the person object. In this way, when an image in a side-view of the person object d is acquired, the image in a front-view of the person object d and the image in a back-view of the person object d may be obtained by using the learned association. For another example (Example 8), the person object e in the sample image a appears in a standing posture and the person object e is in a normal size, the person object f in the sample image b appears in a walking posture, the person object f is in a normal size, and the stride of the person object f is 0.5 meters. Although there is no data on e appearing in walking posture and there is no data on the stride of e, if body shapes of a and b are similar, it is possible to determine the stride of e according to the stride off when the pedestrian re-recognition network determines the stride of e. For example, the probability that the stride of e is 0.5 meters is 90%.

From Example 6, Example 7 and Example 8, it can be seen that it is possible for the pedestrian re-identification training network to learn information of different features by removing the identity information from the first sample probability distribution data, so as to expand training data of different person objects. Continuing to take another example following Example 8, although there is no walking posture of e in the training set, it is possible to obtain the posture and stride of a person similar to the e′ body shape during walking by removing the identity information of f from the probability distribution data of d, and this posture and stride during walking may be applied to e. In this way, the training data of e is expanded.

It is well-known that the training effect of a neural network largely depends on quality and quantity of the training data. The quality of the training data means that the person objects in the image used for training contain appropriate features. For example, it is obviously unreasonable for a man to wear a skirt. If a training image contains a man wearing a skirt, the training image is a low-quality training image. For another example, it is obviously unreasonable for a person to “ride” on a bicycle in a walking posture, and thus, if a training image contains person objects “riding” on a bicycle in a walking posture, the training image is also a low quality training image.

However, in the traditional method of expanding the training data, low-quality training images tend to appear in the training images obtained by expansion. Based on the way of expanding the training data of different person objects by the pedestrian re-identification training network, the embodiments of the present disclosure may acquire a large amount of high-quality training data when training the pedestrian re-identification network by the pedestrian re-identification training network. This can greatly improve the training effect on the pedestrian re-recognition network, and thus can improve the recognition accuracy when the trained pedestrian re-recognition network is used to recognize the identity of the target person object.

In theory, when the second sample mean data and the second sample variance data do not contain the identity information of the person object, the probability distribution data determined by the second sample mean data and the second sample variance data obtained based on different sample images conforms to the same probability distribution data. That is to say, the smaller the smaller the difference between the probability distribution data determined by the second sample mean data and the second sample variance data (hereinafter referred to as a non-identity information sample probability distribution data) and the preset probability distribution data is, the less the identity information of the person object contained in the second sample variance data and the second sample variance data is. Therefore, the embodiment of the present disclosure determines the fifth loss based on the difference between the preset probability distribution data and the second sample probability distribution data, and the difference is positively correlated with the fifth loss. The fifth loss supervises the training process of the pedestrian re-identification training network, which can improve the encoder's ability of removing the identity information of the person objects from the first sample probability distribution data, thereby improving the quality of the expanded training data. Alternatively, the preset probability distribution data is a standard normal distribution.

In a possible implementation, a difference between the non-identity information sample probability distribution data and the preset probability distribution data may be determined by the following formula:

[symbol]

₅=D₅( [symbol] (υ_{μ},υ_{σ})∥ [symbol] (0,I)) Formula (2)

wherein, υ_{μ} is the second sample mean data, υ_{σ} is the second sample variance data, N(υ_{μ}, υ_{σ}) is a normal distribution with the mean value of υ_{μ} and the variance of υ_{σ}, N(0, I) is a normal distribution with the mean value of 0 and the variance of an unit matrix, L₅ is a distance between N(υ_{μ}, υ_{σ}) and N(0, I).

As mentioned above, in the training process, to enable the gradient to be propagated back to the pedestrian re-recognition network, it is necessary to ensure that it is derivable in the pedestrian re-recognition training network. Therefore, after acquiring the second sample mean data and the second sample variance data, the second sample probability distribution data conforming to the first preset probability distribution data is obtained by sampling the second sample mean data and the second sample variance data. The sampling process may be similar to the process of obtaining the first sample probability distribution data by sampling the first sample mean data and the first sample variance data, the description thereof will not be repeated again.

In order to enable the pedestrian re-recognition network to learn the ability of decoupling the variable features from the clothing attributes and appearance features through training, the target data will be selected from the second sample probability distribution data in a predetermined way after acquiring the second sample probability distribution data, and the target data is used to characterize the identity information of the person object in the sample image. For example, the training set includes a sample image a, a sample image b and a sample image c. If the person object d in the sample image a and the person object e in the sample image b are both in a standing posture, and the person object f in the sample object c is in a riding posture, then the target data contains information that the person object f appears in a riding posture.

The predetermined way may be arbitrarily selecting data of multiple dimensions from the second sample probability distribution data. For example, the second sample probability distribution data includes data of 100 dimensions, and it is possible to randomly select data of 50 dimensions as the target data from the data of 100 dimensions.

The predetermined way may also be selecting data of odd dimensions from the second sample probability distribution data. For example, the second sample probability distribution data includes data of 100 dimensions, and it is possible to arbitrarily select data of the first dimension, data of the third dimension, . . . , data of the 99^{th} dimension as the target data from the data of 100 dimensions.

The predetermined way may also be selecting data of the first n dimensions from the second sample probability distribution data, wherein n is a positive integer. For example, the second sample probability distribution data includes data of 100 dimensions, and it is possible to arbitrarily select data of the first 50 dimensions data as the target data from the data of 100 dimensions.

After determining the target data, the data other than the target data in the second sample probability distribution data is regarded as data irrelevant to the identity information (i.e. “irrelevant” in FIG. 9).

To enable the target data to accurately characterize the identity of the sample person object, the third loss is determined based on the difference between the identity result obtained by determining the identity of the person object according to the target data and the labeled data, and the difference is negatively related to the third loss.

In a possible implementation, the third loss L3 may be determined by the following formula:

$${ℒ}_{3} = \{ \begin{matrix}1 - \frac{N - 1}{N} ϵ & i = y \\ ϵ / N & otherwise\end{matrix} \qquad Formula ( 3 )$$

wherein, ϵ is a positive number smaller than 1. N is the number of the identity of the person object in the training set, i is the identity result, and y is the labeled data. Optional, ϵ=0.1.

Alternatively, one-hot encoding processing may be performed on the labeled data to obtain the labeled data after the encoding process, and the labeled data after the encoding process is substituted into the formula (3) as y to calculate the third loss.

For example, the training image set includes 1000 sample images, and these 1000 sample images include 700 different person objects, that is, the number of the identities of the person objects is 700. Assuming ϵ=0.1, if the identity result obtained by inputting the sample image c to the pedestrian re-identification network is 2 and the labeled data of the sample image c is 2, then

$${ℒ}_{3 } = 1 - \frac{N - 1}{N} ϵ = 1 - \frac{700 - 1}{700} * 0.1 = 0.9 ;$$

if the labeled data of the sample image c is 1, then [symbol] ₃=ϵ/N=0.1/700=0.00014.

After acquiring the second sample probability distribution data, it is possible to input the data obtained by splicing the second sample probability distribution data and the labeled data to the decoder, and to obtain a fourth feature data by decoding the spliced data by the decoder.

The process of splicing the second sample probability distribution data and the labeled data may be similar to the process of splicing the first sample probability distribution data and the labeled data, the description thereof will not be repeated again.

It should be understood that, contrary to the previous process of removing the identity information of the person object in the sample image from the first sample probability distribution data by the decoder, splicing processing of splicing the second sample probability distribution data and the labeled data can add the identity information of the person object in the sample image to the second sample probability distribution data. In this way, the second loss may be obtained by measuring the difference between the first sample probability distribution data and the fourth feature data obtained by decoding the second sample probability distribution data. That is, it is possible to determine the effect that the decoupling network extracts the probability distribution data excluding features of identity information from the first sample probability distribution data. That is, the more feature information extracted by the encoder from the first sample probability distribution data is, the smaller the difference between the fourth feature data and the first sample probability distribution data is.

In a possible implementation, the second loss may be obtained by calculating the mean square error between the fourth feature data and the first sample probability distribution data.

That is to say, the data spliced by the first sample probability distribution data and the labeled data are first encoded by the encoder to remove the identity information of the person object from the first sample probability distribution data. This can expand the training data. That is, the pedestrian re-recognition network may learn different feature information from different sample images. By splicing the second sample probability distribution data and the labeled data, the identity information of the person object in the sample image is added to the second sample probability distribution data to measure the validity of the feature information extracted from the first sample probability distribution data by the decoupling network.

For example, it is assumed that the first sample probability distribution data contains five kinds of feature information (for example, color of jacket, color of shoes, posture category, angle of view category, stride), but the feature information extracted from the first sample probability distribution data by the decoupling network only includes four kinds of feature information (for example, color of jacket, color of shoes, posture category and angle of view category), it is meant that the decoupling network discards one feature information (stride) when extracting feature information from the first sample probability distribution data. In this way, the fourth feature data obtained by decoding the data spliced by the labeled data and the second sample probability distribution data only contains the above four feature information (color of jacket, color of shoes, posture category and angle of view category). That is, the feature information contained in the fourth feature data is one less feature information (stride) than the feature information contained in the first sample probability distribution data. In the contrary, if the decoupling network extracts five kinds of feature information from the first sample probability distribution data, the fourth feature data obtained by decoding the data spliced by the labeled data and the second sample probability distribution data would also only contain five kinds of feature information. In this way, the feature information contained in the fourth feature data is the same as that contained in the first sample probability distribution data.

Therefore, it is possible to measure the validity of the feature information extracted by the decoupling network from the first sample probability distribution data based on the difference between the first sample probability distribution data and the fourth feature data, and the difference is negatively correlated with the validity.

In a possible implementation, the first loss may be determined by calculating the mean square error between the third feature data and the sixth feature data.

After determining the first loss, the second loss, the third loss, the fourth loss and the fifth loss, the network loss of the pedestrian re-identification training network may be determined according to these five losses, and parameters of the pedestrian re-identification training network may be adjusted according to the network loss.

In a possible implementation, the network loss of the pedestrian re-identification training network may be determined according to the first loss, the second loss, the third loss, the fourth loss and the fifth loss according to the following formula:

[symbol]

_{T}=λ₁ [symbol] ₁+λ₂ [symbol] ₂+λ₃ [symbol] ₃+λ₄ [symbol] ₄+λ₅ [symbol] ₅ . . . Formula (4)

wherein, L_{T} is the network loss of the pedestrian re-identification training network, L₁ is the first loss, L₂ is the second loss, L₃ is the third loss, L₄ is the fourth loss, L₅ is the fifth loss, λ₁, λ₂, λ₃, λ₄, λ₅ are all natural numbers greater than 0. Alternatively, λ₁=500, λ₂=500, λ₃=1, =1, λ₅=0.05.

Based on the network loss of the pedestrian re-recognition training network, the pedestrian re-recognition training network is trained in a reverse gradient propagation until convergence, and the training of the pedestrian re-recognition training network is completed, that is, the training of the pedestrian re-recognition network is completed.

Alternatively, since the gradient required to update the parameters of the pedestrian re-identification network is reversely transmitted by the decoupling network, if the parameters of the decoupling network are not adjusted, the reversely transmitted gradient may be held up to the decoupling network, that is, the gradient is not reversely transmitted to the pedestrian re-recognition network. This can reduce the amount of data processing required in the training process and improve the training effect of the pedestrian re-recognition network.

In a possible implementation, when the second loss is greater than the preset value, it indicates that the decoupling network has not converged, that is, the parameters of the decoupling network have not been adjusted yet. Thus, the reversely transmitted gradient may be held up to the decoupling network, and only the parameters of the decoupling network are adjusted, but the parameters of the pedestrian re-identification network are not adjusted. When the second loss is less than or equal to the preset value, it indicates that the decoupling network has converged, and the reversely transmitted gradient may be transmitted to the pedestrian re-recognition network to adjust the parameters of the pedestrian re-recognition network until the pedestrian re-recognition training network converges. Then the training of pedestrian re-identification training network is completed.

By using the pedestrian re-identification training network provided by this embodiment, the effect of expanding the training data may be achieved by removing the identity information in the first sample probability distribution data, and then the training effect of the pedestrian re-identification network may be improved. The supervision of the pedestrian re-identification training network through the third loss enables the feature information contained in the target data selected from the second sample probability distribution data to be information for identifying the identity. Then, in conjunction with supervision of the pedestrian re-identification training network by the second loss, it enables the pedestrian re-identification network to decouple the feature information contained in the target data from the feature information contained in the second feature data when processing the third feature data, that is, to decouple the variable features from the clothing attributes and appearance features. In this way, when the trained pedestrian re-recognition network is used to process the feature vectors of the image to be processed, the variable features of the person object in the image to be processed may be decoupled from the clothing attributes and appearance features of the person object, so as to use the variable features of the person object when identifying the identity of the person object, thereby improving identification accuracy.

Based on the image processing method provided in the embodiment (I) and the embodiment (II), the embodiment (IV) of the present disclosure provides a scenario in which the method provided in the embodiment of the present disclosure is applied to catch the suspect.

1101: acquiring a video stream collected by a camera and creating a first database based on the video stream by the image processing device.

The execution subject of this embodiment is a server, and the server is connected to a plurality of cameras each of which is installed in different positions, and the server may acquire a real-time collected video stream from each camera.

It should be understood that the number of cameras connected to the server is not fixed. The network address of the camera is entered to the server, the server acquires the collected video stream from the camera, and then the server creates a first database based on the video stream.

For example, if the managers in place B would like to establish a database in place B, they only need to input the network address of the camera in place B to the server. That is, it is possible for the server to acquire the video stream collected by the camera in place B and the video stream collected by the camera in place B is subjected to a subsequent processing, so as to establish a database in place B.

In a possible implementation, face detection and/or body detection is performed on the images in the video stream (hereinafter referred to as the first image set) to determine the face area and/or body area of each image in the first image set, then the face and/or body area in the first image are cut out to acquire a second image set, and the second image set is stored in the first database. Then the methods provided in the embodiment (I) and the embodiment (III) are used for acquiring the probability distribution data of features of the person object of each image in the database (hereinafter referred to as a first reference probability distribution data), and the first reference probability distribution data is stored in the first database.

It should be understood that the images in the second image set may include only faces or only bodies or include both faces and bodies.

1102. Acquiring a first image to be processed by the image processing device.

In this embodiment, the first image to be processed includes the face of the suspect, or the body of the suspect, or both the face and body of the suspect.

For the method of acquiring the first image to be processed, please refer to the method of acquiring the image to be processed in 201, the description thereof will not be repeated again.

1103. Acquiring probability distribution data of features of a suspect in the first image to be processed as first probability distribution data.

A specific implementation of 1103 may refer to the process of acquiring target probability distribution data of an image to be processed, the description thereof will not be repeated again.

1104. Performing retrieving in the first database using the first probability distribution data to acquire images in the first database that have probability distribution data matching the first probability distribution data as result images.

The specific implementation of 1104 may refer to the process of acquiring the target image in 203, the description thereof will not be repeated again.

In this implementation, when the image of the suspect is obtained by the police, it is possible to use the technical solution provided by the present disclosure to acquire all the images (i.e. result image) containing the suspect from the first database and further determine the track of the suspect based on the collection time and collection location of the result image, so as to reduce the workload of the police to catch the suspects.

Those skilled in the art may understand that in the above method of the specific embodiment, the execution order of the steps does not imply a strict execution order and does not constitute any limitation on the implementation process. The specific execution order of each step should be determined according to its function and possible internal logic.

The method according to the embodiments of the present disclosure has been explained in detail as above and the device according to the embodiments of the present disclosure will be provided below.

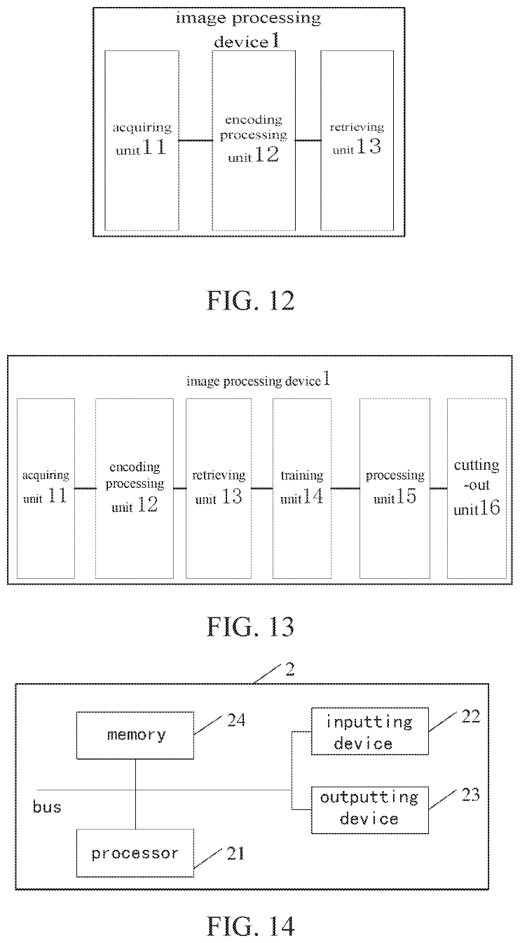

FIG. 12 shows a schematic structural diagram of the image processing device according to an embodiment of the present disclosure. The image processing device 1 includes: an acquiring unit 11, an encoding processing unit 12 and a retrieving unit 13.

The acquiring unit 11 is configured to acquire an image to be processed.

The encoding processing unit 12 is configured to encode the image to be processed to acquire probability distribution data of features of the person object in the image to be processed as target probability distribution data, the features being used for identifying an identity of the person object.

The retrieving unit 13 is configured to acquire, by performing retrieving in a database using the target probability distribution data, images in the database having probability distribution data matching the target probability distribution data, as a target image.

In a possible implementation, the encoding processing unit 12 is specifically configured to perform a feature extraction processing on the image to be processed to acquire a first feature data, and perform a first non-linear transformation on the first feature data to acquire the target probability distribution data.

In another possible implementation, the encoding processing unit 12 is specifically configured to perform a second non-linear transformation on the first feature data to acquire a second feature data, perform a third non-linear transformation on the second feature data to acquire a first processing result as mean data, perform a fourth non-linear transformation on the second feature data to acquire a second processing result as variance data, and determine the target probability distribution data based on the mean data and the variance data.

In yet another possible implementation, the encoding processing unit 12 is specifically configured to perform a convolution processing and a pooling processing on the first feature data in sequence to acquire the second feature data.

In yet another possible implementation, a method performed by the device 1 is applied to a probability distribution data generation network which includes a deep convolution network and a pedestrian re-identification network. The deep convolution network is used to perform a feature extraction processing on the image to be processed to acquire the first feature data and the pedestrian re-identification network is used to encode the feature data to acquire the target probability distribution data.

In yet another possible implementation, the probability distribution data generation network belongs to a pedestrian re-identification training network which further includes a decoupling network. Alternatively, as shown in FIG. 13, the image processing device 1 also includes a training unit 14 for training the pedestrian re-recognition training network. The training process of the pedestrian re-recognition training network includes: acquiring a third feature data by inputting a sample image to the pedestrian re-identification training network and processing the sample image through the deep convolution network; acquiring first sample mean data and first sample variance data by processing the third feature data through the pedestrian re-identification network, the first sample mean data and the first sample variance data are used to describe a probability distribution of features of a person object in the sample image; determining a first loss by measuring a difference between identity of the person object characterized by a first sample probability distribution data determined by the first sample mean data and the first sample variance data and identity of the person object characterized by the third feature data acquiring a second sample probability distribution data by removing identity information of person object in the first sample probability distribution data determined by the first sample mean data and the first sample variance data through the decoupling network; acquiring a fourth feature data by processing the second sample probability distribution data through the decoupling network; determining a network loss of the pedestrian re-identification training network according to the first sample probability distribution data, the third feature data, labeled data of the sample image, the fourth feature data and the second sample probability distribution data; adjusting parameters of the pedestrian re-identification training network based on the network loss.

In yet another possible implementation, the training unit 14 is specifically configured to determine a first loss by measuring a difference between identity of the person object characterized by the first sample probability distribution data and identity of the person object characterized by the third feature data, determine a second loss based on a difference between the fourth feature data and the first sample probability distribution data, determine a third loss based on the second sample probability distribution data and labeled data of the sample image, and acquire a network loss of the pedestrian re-identification training network based on the first loss, the second loss and the third loss.

In another possible implementation, the training unit 14 is further specifically configured to determine a fourth loss based on a difference between identity of the person object determined by the first sample probability distribution data and labeled data of the sample image before acquiring the network loss of the pedestrian re-identification training network based on the first loss, the second loss and the third loss; the training unit is specifically configured to acquire the network loss of the pedestrian re-identification training network based on the first loss, the second loss, the third loss and the fourth loss.

In another possible implementation, the training unit 14 is further specifically configured to determine a fifth loss based on a difference between the second sample probability distribution data and the first preset probability distribution data before acquiring the network loss of the pedestrian re-identification training network based on the first loss, the second loss, the third loss and the fourth loss; the training unit is specifically configured to acquire the network loss of the pedestrian re-identification training network based on the first loss, the second loss, the third loss, the fourth loss and the fifth loss.

In yet another possible implementation, the training unit 14 is specifically configured to select target data from the second sample probability distribution data in a predetermined way, the predetermined way being any one of: arbitrarily selecting data of multiple dimensions from the second sample probability distribution data, selecting data of odd dimensions from the second sample probability distribution data, selecting data of first n dimensions from the second sample probability distribution data, n is a positive integer; determining the third loss based on a difference between identity information of the person object characterized by the target data and the labeled data of the sample image.

In yet another possible implementation, the training unit 14 is specifically configured to acquire a fourth feature data by decoding data obtained after adding identity information of the person object in the sample image to the second sample probability distribution data and determine the third loss based on a difference between identity information of the person object characterized by the target data and labeled data of the sample image.

In yet another possible implementation, the training unit 14 is specifically configured to perform one-hot encoding processing on the labeled data to acquire encoded labeled data, acquire spliced probability distribution data by performing splicing processing on the encoded data and the first sample probability distribution data, and encode the spliced probability distribution data to acquire the second sample probability distribution data.

In yet another possible implementation, the training unit 14 is specifically configured to acquire the first sample probability distribution data by sampling the first sample mean data and the first sample variance data such that the data obtained after the sampling conforms to a preset probability distribution.

In yet another possible implementation, the training unit 14 is specifically configured to acquire a sixth feature data by decoding the first sample probability distribution data and determine the first loss according to a difference between the third feature data and the sixth feature data.

In yet another possible implementation, the training unit 14 is specifically configured to acquire an identity result by determining identity of the person object based on the target data and determine the fourth loss based on a difference between the identity result and the labeled data.

In another possible implementation, the training unit 14 is specifically configured to encode the spliced probability distribution data to acquire a second sample mean data and a second sample variance data, and acquire the second sample probability distribution data by sampling the second sample mean data and the second sample variance data such that the data obtained after the sampling conforms to the preset probability distribution.

In yet another possible implementation, the retrieving unit 13 is configured to determine a similarity between the target probability distribution data and probability distribution data of images in the database, and select an image having a similarity greater than or equal to the preset similarity threshold as the target image.

In yet another possible implementation, the retrieving unit 13 is specifically configured to determine a distance between the target probability distribution data and the probability distribution data of images in the database as the similarity.

In yet another possible implementation, the image processing device 1 further includes the acquiring unit 11 configured to acquire a video stream to be processed before acquiring the image to be processed, a processing unit 15 configured to determine a face area and/or a body area of images in the video stream to be processed by performing a face detection and/or a body detection on the images in the video stream to be processed, and a cutting-out unit 16 configured to acquire the reference image by cutting out the face area and/or the body area, and store the reference image in the database.

In this embodiment, the first feature data is obtained by performing the feature extraction processing on the image to be processed to extract feature information of the person object in the image to be processed. Based on the first feature data, the target probability distribution data of features of the person object in the image to be processed can be obtained, so as to realize the decoupling of the information contained in the variable features in the first feature data from the clothing attributes and appearance features. In this way, the information contained in the variable features may be used during the process of determining the similarity between the target probability distribution data and the reference probability distribution data in the database, so as to further improve accuracy of determining images including a person object belonging to the same identity as the person object in the image to be processed based on the similarity, that is, improve accuracy of identifying the identity of the person objects in the image to be processed.

In some embodiments, the functions possessed by the device or the modules contained therein according to the embodiments of the present disclosure may be used to perform the methods described in the above method embodiments. Specific implementations may refer to the description of the above method embodiments, the description thereof will not be repeated again.

FIG. 14 is a schematic diagram of a hardware structure of another image processing device provided by an embodiment of the present disclosure. The image processing device 2 includes a processor 21, a memory 22, an inputting device 23 and an outputting device 24. The processor 21, the memory 22, the inputting device 23 and the outputting device 24 are coupled via a connector. The connector includes various interfaces, transmission lines or buses, etc., however, the embodiments of the present disclosure are not limited thereto. It should be understood that in the embodiments of the present disclosure, the coupling refers to mutual connection in a specific manner, including a direct connection or an indirect connection via other devices, such as a connection via various interfaces, transmission lines and buses, etc.

The processor 21 may be one or more GPUs. In the case where the processor 21 is one GPU, the GPU may be a single-core GPU or a multi-core GPU. Alternatively, the processor 21 may be a processor group constituted by multiple GPUs, and the multiple processors are coupled to each other via one or more buses. Alternatively, the processor may also be other type of processor, and the embodiments of the present disclosure are not limited thereto.

The memory 22 may be used to store computer program instructions such as various types of computer program codes including program codes for executing the solutions of the present disclosure. Alternatively, the memory 120 includes but is not limited to a non-volatile memory such as embedded multimedia card (EMMC), a universal flash storage (UFS), a read-only memory (ROM), other types of static storage devices capable of storing static information and instructions, or a volatile memory such as a random access memory (RAM) or other types of dynamic storage devices capable of storing information and instructions. The memory 22 can also be an electrically erasable programmable read-only Memory (EEPROM), compact disc read-only memory (CD-ROM) or other optical disc storage (including compact disc, laser disc, optical disc, digital versatile disc, Blu-ray, etc.), magnetic disk storage media or other magnetic storage devices, or any other computer-readable storage media for carrying or storing program code in the form of instructions or data structures and accessible by a computer, etc. The memory 22 is configured to store relevant instructions and data.

The inputting device 23 is configured to input data and/or signals and the outputting device 24 is configured to output data and/or signals. The outputting device 23 and the inputting device 24 may be independent devices or may be an integrated device.

It may be understood that in the embodiment of the present disclosure, the memory 22 may not only be used to store related instructions, but also to store related images and videos. For example, the memory 22 may be used to store the image to be processed or the video stream to be processed obtained by the inputting device 23. Alternatively, the memory 22 may also be used to store target images obtained through search by the processor 21. The embodiments of the present disclosure do not limit the data specifically stored in the memory.

It may be understood that FIG. 14 only shows a simplified design of an image processing device. In practical applications, the image processing device may also include other necessary elements, including but not limited to any number of input/outputting devices, processors, memory, etc., and all image processing devices capable of implementing the embodiments of the present disclosure fall within the scope of protection of the present disclosure.

Those skilled in the art may recognize that the units and calculation steps of the examples described in conjunction with the embodiments disclosed herein may be implemented by electronic hardware, or a combination of computer software and electronic hardware. Whether these functions are executed in hardware or software depends on the specific application and design constraints of the technical solution. Professional technicians may use different methods to implement the described functions for each specific application, but such an implementation should not be considered as going beyond the scope of the present disclosure.

Those skilled in the art may clearly understand that, for the convenience and conciseness of the description, the specific operation processes of the above-described systems, devices, and units may refer to the corresponding processes in the foregoing method embodiments, and the description thereof will not be repeated again. Those skilled in the art may also clearly understand that the descriptions of each embodiment of the present disclosure focus on different aspects. For the convenience and conciseness of description, the same or similar parts may not be repeated in different embodiments. Thus, for the parts that are not described or described in detail in a certain embodiment, please refer to the description thereof in other embodiments.

In the several embodiments provided in the present disclosure, it should be understood that the disclosed system, device and method may be implemented in other ways. For example, the device embodiments described above are only exemplary. For example, a division of the unit is only a division of the logical function. In actual implementation, there may be other divisions, for example, multiple units or components may be combined or integrated into another system, or some features may be ignored, or not implemented. In addition, the displayed or discussed mutual coupling or direct coupling or communication connection may be indirect coupling or communication connection through some interfaces, devices or units, and may be in electrical, mechanical, or other forms.

The units described as separate components may or may not be physically separated, and the components displayed as units may or may not be physical units, that is, they may be located in one place or may be distributed on multiple network units. Some or all of the units may be selected as needed to achieve the purpose of the solution of the embodiments.

In addition, each functional unit in each embodiment of the present disclosure may be integrated into one processing unit, or each unit may exist alone physically, or two or more units integrated into one unit.

The above embodiments may be implemented in whole or in part by software, hardware, firmware or any combination thereof. When implemented by software, it may be implemented in whole or in part in the form of a computer program product. The computer program product includes one or more computer instructions. When the computer program instructions are loaded and executed on the computer, all or part of the processes or functions according to the embodiments of the present disclosure are generated. The computer may be a general-purpose computer, a dedicated computer, a computer network or other programmable devices. The computer instructions may be stored in a computer-readable storage medium or transmitted through the computer-readable storage medium. The computer instructions may be transmitted from a website, a computer, a server or a data center to another website site, computer, server or data center via wired (such as coaxial cable, optical fiber, digital subscriber line (DSL)) or wireless (such as infrared, wireless, microwave) manner. The computer-readable storage medium may be any available medium accessible by a computer or a data storage device including one or more servers, data centers, and the like integrated by available medium. The available media may be magnetic media (e.g., floppy disk, hard disk, magnetic tape), optical media (e.g., digital versatile disc (DVD)), or semiconductor medium (e.g., solid state disk (SSD)).

One skilled in the art may understand that all or part of the processes in the methods according to the foregoing embodiments may be implemented by a computer program instructing related hardware. The program may be stored in a computer-readable storage medium, and when the program is executed, it is possible to include the processes of the foregoing method embodiments. The foregoing storage media include media capable of storing program codes such as a read-only memory (ROM) or a random access memory (RAM), magnetic disks, or optical disks.

What is claimed is:

1. An image processing method comprising:
acquiring an image to be processed;
acquiring, by performing an encoding processing on the image to be processed, probability distribution data of features of a person object in the image to be processed as target probability distribution data, the features being used for identifying an identity of the person object; and
acquiring, by performing retrieving in a database using the target probability distribution data, images in the database having probability distribution data matching the target probability distribution data as a target image.

2. The method according to claim 1, wherein acquiring, by performing the encoding processing on the image to be processed, the probability distribution data of features of the person object in the image to be processed comprises:
acquiring first feature data by performing a feature extraction processing on the image to be processed; and
acquiring the target probability distribution data by performing a first non-linear transformation on the first feature data.

3. The method according to claim 2, wherein acquiring the target probability distribution data by performing the first non-linear transformation on the first feature data comprises:
acquiring second feature data by performing a second non-linear transformation on the first feature data;
acquiring a first processing result as mean data by performing a third non-linear transformation on the second feature data;
acquiring a second processing result as variance data by performing a fourth non-linear transformation on the second feature data; and
determining the target probability distribution data based on the mean data and the variance data.

4. The method according to claim 3, wherein acquiring the second feature data by performing the second non-linear transformation on the first feature data comprises:
acquiring the second feature data by performing a convolution processing and a pooling process on the first feature data in sequence.

5. The method according to claim 1, wherein the method is applied to a probability distribution data generation network which includes a deep convolution network and a pedestrian re-identification network;
the deep convolution network is configured to acquire the first feature data by performing a feature extraction processing on the image to be processed; and
the pedestrian re-identification network is configured to acquire the target probability distribution data by performing the encoding process on the feature data.

6. The method according to claim 5, wherein the probability distribution data generation network belongs to a pedestrian re-identification training network which further includes a decoupling network;
a training process of the pedestrian re-identification training network includes:
acquiring third feature data by inputting a sample image to the pedestrian re-identification training network and processing the sample image through the deep convolution network;
acquiring first sample mean data and first sample variance data by processing the third feature data through the pedestrian re-identification network, the first sample mean data and the first sample variance data being used for describing a probability distribution of features of a person object in the sample image;
acquiring second sample probability distribution data by removing, through the decoupling network, the identity information of person object in the first sample probability distribution data determined by the first sample mean data and the first sample variance data;
acquiring fourth feature data by processing the second sample probability distribution data through the decoupling network;
determining a network loss of the pedestrian re-identification training network based on the first sample probability distribution data, the third feature data, labeled data of the sample image, the fourth feature data, and the second sample probability distribution data; and
adjusting parameters of the pedestrian re-identification training network based on the network loss.

7. The method according to claim 6, wherein determining the network loss of the pedestrian re-identification training network based on the first sample probability distribution data, the third feature data, the labeled data of the sample image, the fourth feature data and the second sample probability distribution data comprises:
determining a first loss by measuring a difference between identity of a person object characterized by the first sample probability distribution data and identity of a person object characterized by the third feature data;
determining a second loss based on a difference between the fourth feature data and the first sample probability distribution data;
determining a third loss based on the second sample probability distribution data and the labeled data of the sample image; and
acquiring the network loss of the pedestrian re-identification training network based on the first loss, the second loss, and the third loss.

8. The method according to claim 7, wherein before acquiring the network loss of the pedestrian re-identification training network based on the first loss, the second loss and the third loss, the method further comprises:
determining a fourth loss based on a difference between the identity of the person object determined by the first sample probability distribution data and the labeled data of the sample image,
acquiring the network loss of the pedestrian re-identification training network based on the first loss, the second loss, and the third loss comprises:
acquiring the network loss of the pedestrian re-identification training network based on the first loss, the second loss, the third loss, and the fourth loss, and/or
wherein before acquiring the network loss of the pedestrian re-identification training network based on the first loss, the second loss, the third loss and the fourth loss, the method further comprises:
determining a fifth loss based on a difference between the second sample probability distribution data and a first preset probability distribution data,
wherein acquiring the network loss of the pedestrian re-identification training network based on the first loss, the second loss, the third loss, and the fourth loss comprises:
acquiring the network loss of the pedestrian re-identification training network based on the first loss, the second loss, the third loss, the fourth loss, and the fifth loss.

9. The method according to claim 7, wherein determining the third loss based on the second sample probability distribution data and the labeled data of the sample image comprises:
selecting target data from the second sample probability distribution data in a predetermined way,
the predetermined way being any one of the following ways:
selecting arbitrarily data of multiple dimensions from the second sample probability distribution data, selecting data of odd dimensions from the second sample probability distribution data, selecting data of first n dimensions from the second sample probability distribution data, n being a positive integer; and
determining the third loss based on a difference between identity information of a person object characterized by the target data and the labeled data of the sample image.

10. The method according to claim 6, wherein acquiring the fourth feature data by processing the second sample probability distribution data through the decoupling network comprises:
acquiring the fourth feature data by performing a decoding processing on data obtained after adding the identity information of the person object in the sample image to the second sample probability distribution data.

11. The method according to claim 6, wherein acquiring the second sample probability distribution data by removing the identity information of person object in the first sample probability distribution data through the decoupling network comprises:
acquiring encoded labeled data by performing a one-hot encoding processing on the labeled data;
acquiring spliced probability distribution data by splicing the encoded data and the first sample probability distribution data; and
acquiring the second sample probability distribution data by performing the encoding processing on the spliced probability distribution data.

12. The method according to claim 6, wherein the first sample probability distribution data is obtained by the following processing:
acquiring the first sample probability distribution data by sampling the first sample mean data and the first sample variance data such that the data obtained by the sampling conforms to a preset probability distribution.

13. The method according to claim 7, wherein determining the first loss by measuring the difference between identity of the person object characterized by the first sample probability distribution data and identity of the person object characterized by the third feature data comprises:
acquiring sixth feature data by performing a decoding processing on the first sample probability distribution data; and
determining the first loss based on a difference between the third feature data and the sixth feature data.

14. The method according to claim 9, wherein determining the third loss based on the difference between the identity information of the person object characterized by the target data and the labeled data comprises:
acquiring an identity result by determining the identity of the person object based on the target data; and
determining the third loss based on a difference between the identity result and the labeled data.

15. The method according to claim 11, wherein acquiring the second sample probability distribution data by performing the encoding processing on the spliced probability distribution data comprises:
acquiring second sample mean data and second sample variance data by performing the encoding processing on the spliced probability distribution data; and
acquiring the second sample probability distribution data by sampling the second sample mean data and the second sample variance data such that data obtained after the sampling conforms to a preset probability distribution.

16. The method according to claim 1, wherein acquiring, by performing retrieving in the database using the target probability distribution data, the images in the database having probability distribution data matching the target probability distribution data as the target image comprises:
determining a similarity between the target probability distribution data and the probability distribution data of the images in the database; and
selecting an image having the similarity greater than or equal to a preset similarity threshold as the target image.

17. The method according to claim 16, wherein determining the similarity between the target probability distribution data and the probability distribution data of the images in the database comprises:
determining, as the similarity, a distance between the target probability distribution data and the probability distribution data of the images in the database.

18. The method according to claim 1, wherein, before acquiring the image to be processed, the method further comprises:
acquiring video stream to be processed;
determining a face and/or body area of images in the video stream to be processed by performing a face and/or body detection on the images in the video stream to be processed; and
acquiring a reference image by cutting out the face and/or body area, and storing the reference image in the database.

19. An image processing device comprising:
a processor; and
a memory configured to store processor-executable instructions,
wherein the processor is configured to execute the instructions stored in the memory, so as to:
acquire an image to be processed;
acquire, by performing an encoding processing on the image to be processed, probability distribution data of features of a person object in the image to be processed as target probability distribution data, the features being used for identifying identity of the person object; and
acquire, by performing retrieving in a database using the target probability distribution data, images in the database having probability distribution data matching the target probability distribution data as a target image.

20. A non-transitory computer-readable storage medium having computer program including program instructions stored thereon, wherein when the program instructions are executed by a processor of an electronic device, an image processing method is caused to be executed by the processor, the method comprising:
acquiring an image to be processed;
acquiring, by performing an encoding processing on the image to be processed, probability distribution data of features of a person object in the image to be processed as target probability distribution data, the features being used for identifying an identity of the person object; and
acquiring, by performing retrieving in a database using the target probability distribution data, images in the database having probability distribution data matching the target probability distribution data as a target image.
